(19) United States
(12) Patent Application Publication
(10) Pub. No.: US 2007/0085662 A1
(43) Pub. Date: Apr. 19, 2007

(54) Visitor reception system with improved security by limiting visitors authorized to enter, outdoor unit and communication terminal included in the same

(75) Inventors: Fumiaki Matsumoto, Higashi Osaka City (JP); Michiaki Koizumi, Daito City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/546,412

(22) Filed: Oct. 12, 2006

(30) Foreign Application Priority Data
Oct. 14, 2005 (JP) 2005-299938

(51) Int. Cl. H04Q 5/22

(52) U.S. Cl. 340/10.1; 340/10.42; 340/426.2; 340/5.82; 340/5.8

(57) ABSTRACT

In order to improve security by limiting visitors authorized to enter, a visitor reception system includes an outdoor unit and a communication terminal capable of communicating with the outdoor unit. The outdoor unit includes a short-range communication portion to communicate with a mobile phone, a communication I/F to communicate with the communication terminal, and a control portion to obtain a telephone number from a mobile phone through the short-range communication portion and transmit the obtained telephone number to the communication terminal through the communication I/F. The communication terminal includes an EEPROM to store a telephone number, a first communication I/F to communicate with the outdoor unit, and a control portion to receive the telephone number of a mobile phone from the outdoor unit through the first communication I/F and give notification of a visitor on condition that the received telephone number is stored in EEPROM.

This application is based on Japanese Patent Application No. 2005-299938 filed with Japan Patent Office on Oct. 14, 2005, the entire content of which is hereby incorporated by reference.

### BACKGROUND OF THE INVENTION

1. Field of the Invention

The present invention relates to a visitor reception system, an outdoor unit and a communication terminal, and more particularly to a visitor reception system with improved security by limiting visitors authorized to enter, an outdoor unit and a communication terminal included in the same.

2. Description of the Related Art

The conventional visitor reception system known as a door entry intercom cannot identify a visitor and thus inform a person indoors that he has a visitor whoever the visitor is. Therefore, for example, even if the visitor is disguised as a deliveryman with the intention of intrusion, the person indoors is inevitably informed so that security cannot be maintained. Moreover, the conventional visitor reception system informs all persons indoors that they have a visitor even when the visitor intends to visit one of a plurality of persons indoors. Accordingly, a person irrelevant to the visitor is informed of the visitor.

Japanese Patent Laying-Open No. 2000-293772 discloses an entry control system including a connection unit receiving an incoming call from a telephone, a telephone number comparison unit for making a first comparison between a telephone number unique to the telephone and a telephone number registered beforehand, an input unit for inputting prescribed information, an input information comparison unit for making a second comparison between information and information stored beforehand, and a monitor unit including a controller controlling locking or unlocking of a monitor target based on the result of the first and second comparison.

However, the technique disclosed in Japanese Patent Laying-Open No. 2000-293772 requires a person who intends to enter to make a call and needs an operation for entry which is cumbersome and involves communication costs.

### SUMMARY OF THE INVENTION

The present invention is made to solve the aforementioned problems. An object of the present invention is to provide a visitor reception system with improved security by limiting visitors authorized to enter.

Another object of the present invention is to provide an outdoor unit to facilitate detection and identification of a visitor.

A further object of the present invention is to provide a communication terminal with improved security by limiting visitors authorized to enter.

Yet another object of the present invention is to provide a visitor reception system capable of informing only a person who needs to be informed that he has a visitor.

In order to achieve the aforementioned object, according to an aspect of the present invention, a visitor reception system includes an outdoor unit installed outdoors and a communication terminal capable of communicating with the outdoor unit. The outdoor unit includes a first communication portion to communicate with a radio terminal within a prescribed distance, a second communication portion to communicate with the communication terminal, an identification information obtaining portion to obtain identification information of the radio terminal from the radio terminal through the first communication portion, and an identification information transmission portion to transmit the obtained identification information to the communication terminal through the second communication portion in response to obtaining of the identification information by the identification information obtaining portion. The communication terminal includes an identification information registration portion to register identification information, a third communication portion to communicate with the outdoor unit, an identification information reception portion to receive the identification information of the radio terminal from the outdoor unit through the third communication portion, and a notification portion to give notification of a visitor in response to reception of the identification information by the identification information reception portion, on condition that the received identification information is registered in the identification information registration portion.

According to another aspect of the present invention, an outdoor unit capable of communicating with a communication terminal includes: a first communication portion to communicate with a radio terminal within a prescribed distance; a second communication portion to communicate with the communication terminal; an identification information obtaining portion to obtain identification information of the radio terminal from the radio terminal through the first communication portion; and an identification information transmission portion to transmit the obtained identification information to the communication terminal through the second communication portion in response to obtaining of the identification information by the identification information obtaining portion.

According to a further aspect of the present invention, a communication terminal capable of communicating with an outdoor unit installed outdoors includes: an identification information registration portion to register identification information; a communication portion to communicate with the outdoor unit; an identification information reception portion to receive identification information of a radio terminal within a prescribed distance from the outdoor unit through the communication portion; and a notification portion to give notification of a visitor in response to reception of the identification information by an identification information reception portion, on condition that the identification information is registered in the identification information registration portion.

In accordance with yet another aspect of the present invention, a visitor reception system includes an outdoor unit installed outdoors and a plurality of communication terminals capable of communicating with the outdoor unit. The outdoor unit includes a first communication portion to communicate with a radio terminal within a prescribed distance, a second communication portion to communicate with the communication terminal, an identification information obtaining portion to obtain identification information of the radio terminal from the radio terminal through the first communication portion, and an identification information transmission portion to transmit the obtained identification information to the plurality of communication terminals through the second communication portion, in response to obtaining of the identification information by the identification information obtaining portion. Each of the plurality of communication terminals includes an identification information registration portion to register identification information, a third communication portion to communicate with the outdoor unit, an identification information reception portion to receive the identification information of the radio terminal from the outdoor unit through the third communication portion, and a notification portion to give notification of a visitor in response to reception of the identification information by the identification information reception portion, on condition that the identification information is registered in the identification information registration portion.

In accordance with a still further aspect of the present invention, a visitor reception system includes: a registration portion to register beforehand identification information for identifying a radio terminal; an identification information obtaining portion to communicate with a radio terminal carried by a visitor to obtain identification information of the radio terminal; and a notification portion to give notification of a visitor in response to obtaining of the identification information by the identification information obtaining portion, on condition that the identification information is registered in the identification information registration portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing a configuration of a visitor reception system in a first embodiment of the present invention.

FIG. 2 is a diagram showing an exemplary format of authorized person data stored in a communication terminal.

FIG. 3 is a flowchart illustrating an exemplary flow of an authorized person data registration process performed in the communication terminal.

FIG. 4A is a first flowchart illustrating a visitor reception process performed in an outdoor unit.

FIG. 4B is a first flowchart illustrating a visitor notification process performed in the communication terminal.

FIG. 5 is a diagram showing an exemplary window appearing on a display portion of the communication terminal.

FIG. 6 is a diagram schematically showing a configuration of a visitor reception system in a second embodiment.

FIG. 7 is a block diagram schematically showing a configuration of a first mobile phone in the second embodiment.

FIG. 8 is a diagram showing an exemplary format of authorized person data stored in the first mobile phone.

FIG. 9 is a flowchart illustrating an exemplary flow of an authorized person data registration process performed in the first mobile phone.

FIG. 10A is a second flowchart illustrating a visitor reception process performed in an outdoor unit.

FIG. 10B is a second flowchart illustrating a visitor notification process performed in a mobile phone.

### DESCRIPTION OF THE PREFERRED EMBODIMENT

In the following, an embodiment of the present invention will be described with reference to the figures. In the following description, the same parts will be denoted with the same reference characters. Their designations and functions are also the same. Therefore, detailed description thereof will not be repeated.

### FIRST EMBODIMENT

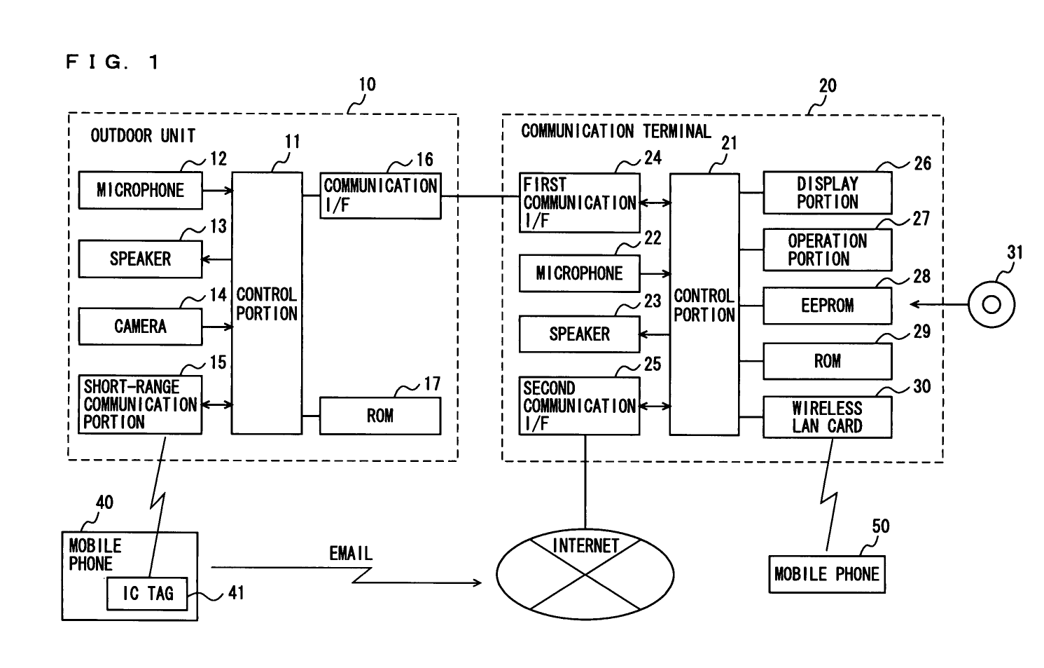

FIG. 1 is a diagram schematically showing a configuration of a visitor reception system in a first embodiment of the present invention. Referring to FIG. 1, the visitor reception system includes an outdoor unit 10 and a communication terminal 20. Outdoor unit 10 is installed outside, for example, at an entrance. Communication terminal 20 is installed indoors. A mobile phone 40 carried by a visitor has an IC tag 41 attached thereto. IC tag 41 includes a communication portion for communications via electromagnetic waves and a semiconductor memory such as an EEPROM (Electronically Erasable and Programmable ROM) to store information in a nonvolatile manner. The semiconductor memory of IC tag 41 stores a telephone number or ESN (Electronic Serial Number) allocated to mobile phone 40 beforehand as identification information for identifying mobile phone 40.

Outdoor unit 10 includes a control portion 11 for controlling the entire outdoor unit 10, a microphone 12, a speaker 13, a camera 14, a short-range communication portion 15 for short-range communication with IC tag 41 of mobile phone 40, a communication I/F 16 for connecting outdoor unit 10 to communication terminal 20, and an ROM (Read Only Memory) 17 for storing a visitor reception program executed by control portion 11.

Short-range communication portion 15 communicates with IC tag 41 of mobile phone 40. Short-range communication portion 15 has a communication distance limited to a prescribed range of distance. Therefore, when mobile phone 40 enters within the prescribed range of distance from short-range communication portion 15, short-range communication portion 15 becomes able to communicate with IC tag 41 attached to mobile phone 40. Short-range communication portion 15 communicates with IC tag 41 to receive from IC tag 41 the identification information of mobile phone 40 stored in the semiconductor memory of the IC tag. The longest distance within which short-range communication portion 15 can communicate with IC tag 41 is, for example, at least about 10 cm. The communication method in the communication between short-range communication portion 15 and IC tag 41 is known as NFC (Near Field Communication) for use in a non-contact type IC card. Camera 14 is installed at a location where the face of a visitor is within the image pick-up range of camera 14 when a visitor who is the owner of mobile phone 40 is in such a position in that he brings mobile phone 40 close to short-range communication portion 15 of outdoor unit 10.

Communication terminal 20 includes a control portion 21 for controlling the entire communication terminal 20, a microphone 22, a speaker 23, a first communication I/F 24 for connecting communication terminal 20 with outdoor unit 10, a second communication I/F 25 for connecting communication terminal 20 with the Internet, a display portion 26, an operation portion 27, an EEPROM 28 for storing authorized person data in a nonvolatile manner, an ROM 29 for storing a program executed by control portion 21, and a wireless LAN card 30 for wirelessly connecting communication terminal 20 with a mobile phone 50. Communication terminal 20 may be realized by a general computer.

Operation portion 27 is an input device such as a keyboard or mouse for accepting an input of an operation by the user of communication terminal 20. Display portion 26 is a liquid crystal display or an organic EL (Electro-Luminescence) display panel. Operation portion 27 and display portion 26 may be integrated to form a touch panel. The connection form between communication terminal 20 and outdoor unit 10 may be wired or wireless. The communication protocol between first communication I/F 24 of communication terminal 20 and communication I/F 16 of outdoor unit 10 is defined according to the connection form between communication terminal 20 and outdoor unit 10. Second communication I/F 25 is a communication interface for connecting communication terminal 20 with the Internet. Thus, communication terminal 20 is able to communicate with other computers and receive an email transmitted by mobile phone 40.

Control portion 21 reads and executes an authorized person registration program and a visitor reception program stored in ROM 29. The program executed by control portion 21 is not limited to the authorized person registration program and the visitor reception program stored in ROM 29. Control portion 21 may download an authorized person registration program and a visitor reception program from another computer connected to the Internet and execute the authorized person registration program and the visitor reception program. Furthermore, control portion 21 may read and execute the one recorded in a CD-ROM (Compact Disk ROM) 31. The program referred to herein includes not only a program that can directly be executed by control portion 21 but also a program in a source program format, a compressed program, an encrypted program, and the like. It is noted that the recording medium having the authorized person registration program and the visitor reception program stored therein may be a flexible disk, a cassette tape, an optical disk (MO (Magnetic Optical Disc)/MD (Mini Disc)/DVD (Digital Versatile Disc)), an IC card (including a memory card), an optical card, a semiconductor memory such as a mask ROM, EPROM, EEPROM, or the like.

It is noted that although wireless LAN card 30 is used for communication terminal 20 to communicate with mobile phone 50 in the present embodiment, a communication unit allowing communications in a wireless communication standard such as Bluetooth or HomeRF (Radio Frequency) may be used.

The visitor reception system in this embodiment identifies a visitor using the identification information of mobile phone 40 owned by the visitor. Therefore, short-range communication portion 15 receives a telephone number or ESN allocated to mobile phone 40 by short-range communication with IC tag 41 attached to mobile phone 40. When outdoor unit 10 receives a telephone number or ESN from mobile phone 40, outdoor unit 10 transmits the telephone number or ESN to communication terminal 20. Meanwhile, communication terminal 20 stores a telephone number or ESN allocated to a mobile phone owned by a person to be authorized, beforehand as authorized person data in EEPROM 28. Upon reception of a telephone number or ESN from outdoor unit 10, communication terminal 20 searches for the authorized person data to decide whether the entry is permitted or not. If the entry of a visitor is permitted, communication terminal 20 notifies the user of communication terminal 20 that he has a visitor, and if the entry of a visitor is not permitted, communication terminal 20 does nothing.

The authorized person data stored in communication terminal 20 is registered in communication terminal 20 by the user of communication terminal 20. Since the user of communication terminal 20 knows in advance the telephone number or ESN allocated to the mobile phone owned by his acquaintance, the user can register the telephone number or ESN of the mobile phone owned by the acquaintance into communication terminal 20. However, if a visitor is a deliveryman or the like, the user does not know in advance a telephone number or ESN allocated to a mobile phone owned by a visitor. Therefore, communication terminal 20 in this embodiment receives the telephone number or ESN allocated to a mobile phone owned by a visitor via email before the visitor visits. For example, if the prospective visitor is a deliveryman, the deliveryman transmits the telephone number or ESN allocated to mobile phone 40 owned by the deliveryman via email to communication terminal 20 before visiting. Furthermore, the sender of a parcel may transmit the telephone number or ESN allocated the mobile phone owned by the sender to communication terminal 20 via email and additionally informs the deliveryman by telephone or the like of that telephone number or ESN, which is then stored in IC tag 41 of mobile phone 40 owned by the deliveryman.

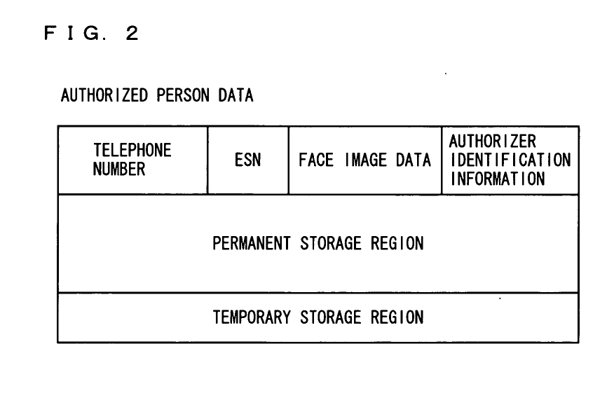

FIG. 2 is a diagram showing an exemplary format of authorized person data stored in the communication terminal. The authorized person data is stored in EEPROM 28 of communication terminal 20. FIG. 2 shows a storage region of EEPROM 28. The authorized person data includes a telephone number, ESN, face image data, and authorizer information. The telephone number is a unique telephone number allocated to a mobile phone. ESN is a unique number allocated to a mobile phone. The face image data is image data obtained by picking up an image of the owner of a mobile phone. The authorizer identification information is information for identifying the user of the communication terminal. The authorized person data always includes one of a telephone number and ESN and may include both. It is noted that the authorizer identification information is not necessary if there is only one user of the communication terminal 20.

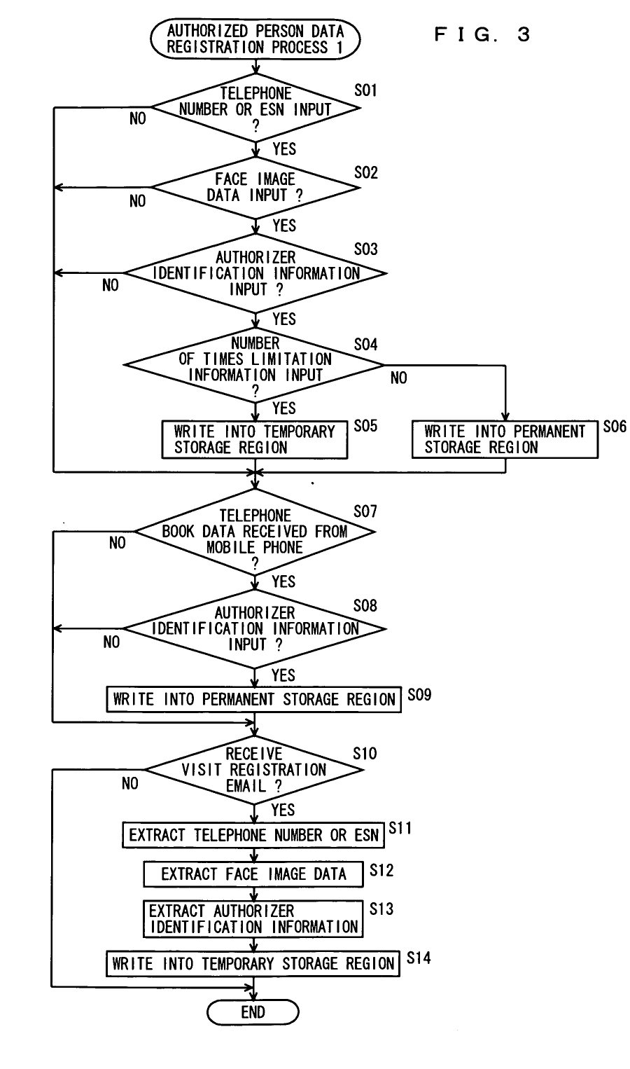

FIG. 3 is a flowchart illustrating an exemplary flow of the authorized person data registration process performed in the communication terminal. The authorized person data registration process is performed in control portion 21 by control portion 21 of communication terminal 20 executing the authorized person data registration program stored in ROM 29. Referring to FIG. 3, control portion 21 determines whether or not a telephone number or ESN is input (step S01). The telephone number or ESN is input to communication terminal 20 by the user operating communication terminal 20. Control portion 21 causes an input window for the user to input a telephone number or ESN to appear on display portion 26. The user inputs a telephone number or ESN to operation portion 27, so that control portion 21 obtains the telephone number or ESN. If the telephone number or ESN is input, control portion 21 proceeds to step S02, and if not input, the process proceeds to step S07.

At step S02, control portion 21 determines whether or not face image data is input. The face image data is image data obtained by picking up an image of the face of the owner of the mobile phone having the telephone number or ESN input at step S01. The face image data may be stored beforehand in EEPROM 28 or CD-ROM 31 and read by control portion 21. Alternatively, control portion 21 may allow wireless LAN card 30 to receive face image data from the mobile phone 50 of the user of communication terminal 20 or may allow second communication I/F 25 to receive face image data from a computer connected to the Internet. Control portion 21 causes an input window to appear on display portion 26 for the user to designate a source (record resource) of face image data and determines whether or not designation of a source is input to operation portion 27 by the user. If designation of a source is accepted, control portion 21 obtains face image data from the designated source and proceeds to step S02. If designation of a source is not accepted, the process proceeds to step S07.

At step S03, control portion 21 determines whether or not the authorizer identification information is input. The authorizer identification information is identification information allocated to the user who registers the authorized person data among a plurality of users of communication terminal 20. More specifically, it is the identification information allocated to the user who inputs a telephone number or ESN at step S01. Here, the authorizer identification information is the name of the user. The authorizer identification information may be information that allows the user to be distinguished from other users and may be, for example, a code allocated for each user, a nickname, or the like. Control portion 21 causes an input window for the user to input the authorizer identification information to appear on display portion 26. The user inputs the authorizer identification information to operation portion 27 so that control portion 21 obtains the authorizer identification information. If the user identification information of the user who uses communication terminal 20 has already been stored in communication terminal 20, the input window may include a list of the stored user identification information. In this case, the user selects one user identification information from the list displayed in the input window, so that the user can input the user identification information in communication terminal 20. If the authorizer identification information is input, control portion 21 proceeds to step S04. If not input, the process proceeds to step S07. It is noted that if there is only one user, step S03 is unnecessary.

At step S04, control portion 21 determines whether or not number of times limitation information is input. The number of times limitation information is information indicating that the visit of the owner of the mobile phone having the telephone number or ESN input at step S01 is authorized only once. The number of times limitation information is input to operation portion 27 by the user of communication terminal 20. Control portion 21 causes a window for the user to input the number of times limitation information to appear on display portion 26. The user inputs the number of times limitation information to operation portion 27, so that control portion 21 obtains the number of times limitation information. When the number of times limitation information is input, control portion 21 proceeds to step S05. If not input, the process proceeds to step S06. It is noted that although control portion 21 causes an input window to appear on display portion 26 at each of step S01-step S04, the input windows displayed at step S01-step S04 may be displayed on display portion 26 at the same time.

At step S05, control portion 21 generates authorized person data based on the telephone number or ESN obtained at step S01, the face image data obtained at step S02 and the authorizer identification information obtained at step S03 for storage into a temporary storage region of EEPROM 28. On the other hand, at step S06, control portion 21 generates authorized person data based on the telephone number or ESN obtained at step S01, the face image data obtained at step S02 and the authorizer identification information obtained at step S03 for storage into a permanent storage region of EEPROM 28.

At step S07, control portion 21 determines whether or not telephone book data is received from mobile phone 50 owned by the user of communication terminal 20. If telephone book data is received at wireless LAN card 30, control portion 21 proceeds to step S08. If not received, the process proceeds to step S10. In other words, control portion 21 proceeds to step S08 on condition that telephone book data from mobile phone 50 owned by the user of communication terminal 20 is received from wireless LAN card 30. It is noted that although here the telephone book data is received from wireless LAN card 30 by way of example, the telephone book data may be received from mobile phone 50 using other communication methods such as IrDA, or the telephone book data may be received from mobile phone 50 by connecting communication terminal 20 with mobile phone 50 using a USB cable.

At step S08, control portion 21 determines whether or not the authorizer identification information is input. The authorizer identification information here is the authorizer identification information allocated to the owner of mobile phone 50 that has transmitted the telephone book data to communication terminal 20 at step S07. Control portion 21 may receive authorizer identification information when the telephone book data is received from mobile phone 50 at step S07. If the authorizer identification information is input, control portion 21 proceeds to step S09. If not input, the process proceeds to step S10. It is noted that if there is only one user of communication terminal 20, step S08 is unnecessary. At step S09, control portion 21 generates authorized person data based on the telephone number included in the telephone book data received at step S07, the face image data and the authorizer identification information accepted at step S08 and stores the same in the permanent storage region of EEPROM 28. It is noted that if the telephone numbers are grouped in the telephone book data, only a telephone number classified in a particular group, for example, of family or friends may be stored as authorized person data in EEPROM 28. In addition, a telephone number stored as an outgoing call history or an incoming call history in mobile phone 50 may be stored as authorized person data in EEPROM 28. In this case, only a telephone number of outgoing calls or incoming calls over a prescribed number of times may be stored as authorized person data in EEPROM 28.

At step S10, control portion 21 determines whether or not a visit registration email is received. The visit registration email is an email at least including a telephone number or ESN of a person who pays a visit, of emails received at second communication I/F 25. The header portion or the subject of the email includes information indicating a visit registration email. The visit registration email may include face image data obtained by picking up an image of the face of a person who pays a visit or information for specifying a visited person. Here, the visit registration email includes the telephone number or ESN and face image data of a person who pays a visit and information for specifying a visited person, by way of illustration. Furthermore, the information for specifying a visited person is the name of the visited person, that is, authorizer identification information. If the visit registration email is received at second communication I/F 25, control portion 21 proceeds to step S11. If the visit registration email is not received, the process ends. When the visit registration email is received at second communication I/F 25, control portion 21 extracts a telephone number or ESN (step S11), extracts face image data (step S12) and extracts authorizer identification information (step S13) from that visit registration email. Then, control portion 21 generates authorized person data based on the telephone number or ESN extracted at step S11, the face image data extracted at step S12 and the authorizer identification information extracted at step S13 and stores the same in the temporary storage region of EEPROM 28 (step S14).

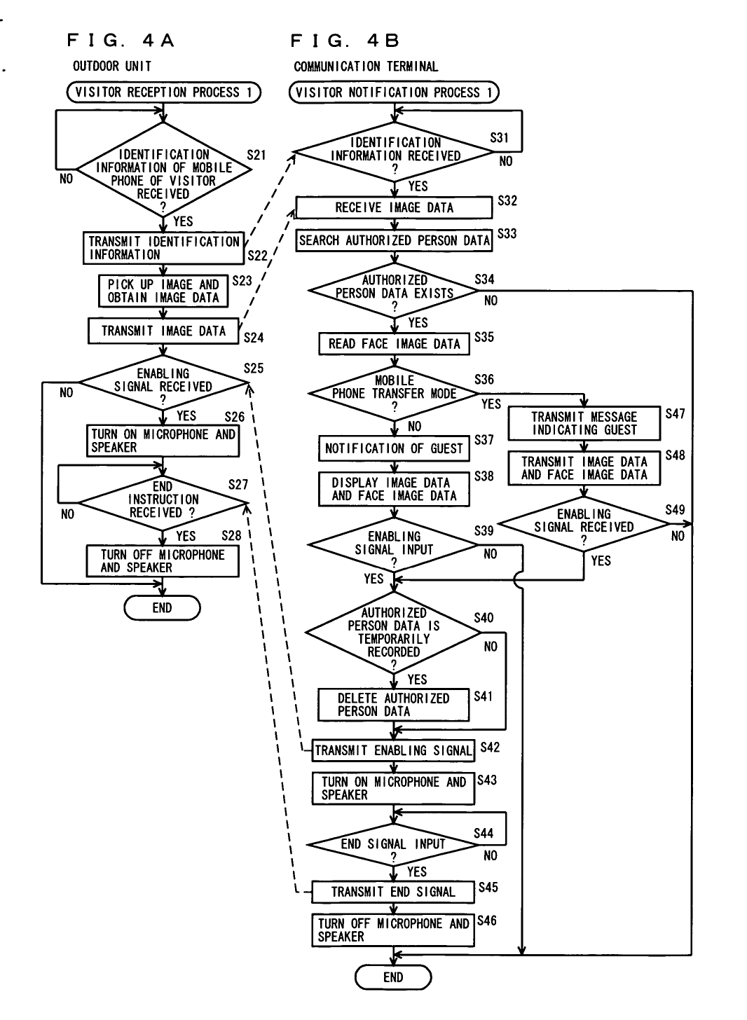

FIG. 4A is a first flowchart illustrating a visitor reception process performed in the outdoor unit. The visitor reception process is a process executed in control portion 11 by control portion 11 executing a visitor reception program stored in ROM 17. FIG. 4B is a first flowchart illustrating a visitor notification process performed in a the communication terminal. The visitor notification process is performed in control portion 21 by control portion 21 executing a visitor notification program stored in ROM 29.

Referring to FIG. 4A, control portion 11 of outdoor unit 10 determines whether or not the identification information of mobile phone 40 is received at short-range communication portion 15 from IC tag 41 attached to mobile phone 40 owned by a visitor (step S21). Control portion 11 is in the standby state until the identification information of mobile phone 40 is received at short-range communication portion 15 from IC tag 41 (No at step S21). When the identification information is received at short-range communication portion 15, the process proceeds to step S22. In other words, control portion 11 performs the process after step S22 on condition that the identification information of mobile phone 40 is received at short-range communication portion 15 from IC tag 41. The identification information is the telephone number or ESN allocated to mobile phone 40. Short-range communication portion 15 receives the identification information from IC tag 41 of mobile phone 40 when mobile phone 40 enters within a prescribed range of distance from short-range communication portion 15. Thus, detection by control portion 21 of an event in which the identification information is received at short-range communication portion 15 corresponds to detection of a visitor.

Control portion 11 transmits the identification information of mobile phone 40 received at step S21 to communication terminal 20 through communication I/F 16 (step S22). Then, control portion 11 drives camera 14 to allow camera 14 to pick up an image (step S23). Accordingly, camera 14 outputs image data obtained by imaging the face of a visitor. Control portion 11 obtains the image data output by camera 14 for transmission to communication terminal 20 through communication I/F 16 (step S24). Control portion 11 detects reception of an enabling signal transmitted from communication terminal 20 at step S25. If an enabling signal is received at communication I/F 16, control portion 11 proceeds to step S26. If not received, the process ends. The enabling signal will be described later.

At step S26, control portion 11 turns on microphone 12 and speaker 13. Control portion 11 turns on microphone 12 and speaker 13 to bring outdoor unit 10 into the call-enabled state. Specifically, control portion 11 transmits voice data output from microphone 12 picking up sounds to communication terminal 20 through communication I/F 16, applies the voice data received at communication I/F 16 to speaker 13 and allows speaker 13 to generate sound. In addition, control portion 11 transmits image data output from camera 14 to communication terminal 20 through communication I/F 16. At step S27, control portion 11 determines whether or not an end signal is received from communication terminal 20. Control portion 11 enters the standby state until input of an end signal (NO at step S27) and maintains the call-enabled state of outdoor unit 10. When the end signal is received, control portion 11 proceeds to step S28. The end signal will be described later. At step S28, control portion 11 turns off microphone 12 and speaker 13 to bring outdoor unit 10 into the call-disabled state. Then, control portion 11 ends the process.

Referring to FIG. 4B, control portion 21 of communication terminal 20 determines whether or not the identification information is received from outdoor unit 10 (step S31). Control portion 21 is in the standby state until the identification information is received at communication I/F 24 (NO at step S31). Upon reception of the identification information, the process proceeds to step S32. In other words, control portion 21 performs the process after step S32 on condition that the identification information is received at communication I/F 24. At step S31, control portion 21 receives the image data transmitted from outdoor unit 10. Then, control portion 21 searches the authorized person data stored in EEPROM 28 using the identification information received at step S31 as a key (step S33). Control portion 21 determines whether or not the authorized person data that includes the identification information received at step S31 is stored in EEPROM 28 (step S34). If the authorized person data that includes the identification information received at step S31 is stored in EEPROM 28, control portion 21 proceeds to step S35. If not, the process ends. At step S35, the face image data of the authorized person data that includes the identification information received at step S31 is read from EEPROM 28.

Then, control portion 21 determines whether or not a transfer mode is set (step S36). The transfer mode is a mode in which the receiver of the notification of a visitor is mobile phone 50 of the owner of communication terminal 20. Communication terminal 20 is set beforehand in either the transfer mode or a non-transfer mode that is not the transfer mode by the user of communication terminal 20. The setting of the transfer mode and the non-transfer mode is conducted by turning on or off a DIP switch of operation portion 27. Alternatively, control portion 21 may store that the transfer mode is set in EEPROM 28 according to a signal input to operation portion 27 by the user. If communication terminal 20 is set in the transfer mode, control portion 21 proceeds to step S47, and if set in the non-transfer mode, control portion 21 proceeds to step S37.

At step S37, control portion 21 allows speaker 23 to output a door bell sound in order to give notification of a guest to display portion 26. In addition, control portion 21 may display a prescribed message on display portion 26 together with the sound output. The message may include the authorizer identification information of the authorized person data that includes the identification information received at step S31. The message here is, for example, “(the name of the visited person) has a guest.” Thus, even if there are a plurality of users of communication terminal 20, it can be known who of a plurality of users has a guest. Additionally, the name of the owner of mobile phone 40 may be associated with the authorized person data, or the telephone number or ESN of the authorized person data and the name of the owner of mobile phone 40 may be associated with each other, so that the name of the guest can be specified based on the authorized person data that includes the identification information received at step S31. Therefore, a message, for example, “you have a guest (the name of a guest)” may be displayed. Thus, the user of communication terminal 20 is informed of who is a visitor.

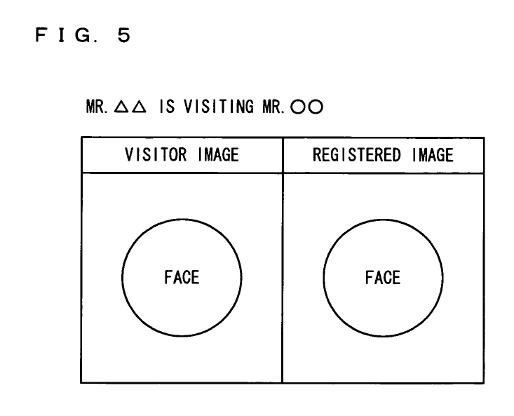

Control portion 21 displays the image data received at step S32 and the face image data read at step S35 side by side on display portion 26 (step S38). FIG. 5 is a diagram showing an exemplary window appearing on the display portion of the communication terminal. It is noted that although in the figure, the characters “FACE” are represented in the circle object, the image obtained by picking up an image of the face is actually displayed. Referring to FIG. 5, the image of the visitor's face and the image of the face of the owner of mobile phone 40 are displayed side by side at the same time on the display portion. Therefore, the user of communication terminal 20 can confirm by the image that the owner of mobile phone 40 is identical with the visitor. It is noted that the image data referred to herein is not limited to still images and includes moving images.

Returning to FIG. 4B, at step S39, control portion 21 determines whether or not an enabling signal is input. The enabling signal is a signal given by the user of communication terminal 20 to communication terminal 20, enabling the user of communication terminal 20 to have a conversation with a visitor in the vicinity of outdoor unit 10. The user of communication terminal 20 inputs the enabling signal to operation portion 27 so that control portion 21 obtains the enabling signal. Upon reception of the enabling signal, control portion 21 proceeds to step S40. If the enabling signal is not input, the process ends.

Meanwhile, at step S47, control portion 21 transmits a prescribed message to mobile phone 50 of the user of communication terminal 20 through wireless LAN card 30 to give notification that he has a visitor. Accordingly, the user of mobile phone 50 is informed that he has a visitor even if he is located away from communication terminal 20. The transmitted message may include ringing sounds. If there are a plurality of users of communication terminal 20 and a plurality of user own their respective mobile phones 50, control portion 21 specifies one of a plurality of mobile phones 50 based on the authorizer identification information of the authorized person data that includes the identification information received at step S31 and transmits the message only to the specified mobile phone 50. Accordingly, the message is transmitted only to the visited person and the message is not transmitted to a person irrelevant to the visit of the visitor. In addition, the name of the owner of mobile phone 40 may be associated with the authorized person data, or the telephone number or ESN of the authorized person data and the name of the owner of mobile phone 40 may be associated with each other, so that the name of the guest can be specified based on the authorized person data that includes the identification information received at step S31. Therefore, for example, a message “you have a guest (the name of a guest)” may be transmitted. Accordingly, the user of mobile phone 50 can be informed of who is a visitor.

Control portion 21 transmits the image data received at step S32 and the face image data read at step S35 to mobile phone 50 of the user of communication terminal 20 through wireless LAN card 30 (step S48). At mobile phone 50, the received two image data are displayed side by side on the liquid crystal display thereof. A window similar to the one shown in FIG. 5 can be displayed on the liquid crystal display of mobile phone 50. Therefore, the user of mobile phone 50 can confirm by the image that the owner of mobile phone 40 is identical with the visitor. At step S49, control portion 21 determines whether or not the enabling signal is received from mobile phone 50 by wireless LAN card 30. The enabling signal is input to mobile phone 50 by the user of mobile phone 50 pressing the keyboard, for example, the call button of mobile phone 50 and is transmitted from mobile phone 50 to communication terminal 20. If the enabling signal is received by wireless LAN card 30, control portion 21 proceeds to step S40. If the enabling signal is not received, the process ends.

At step S40, control portion 21 determines whether or not the authorized person data that includes the identification information received at step S31 is stored in the temporary storage region of EEPROM 28. If stored in the temporary storage region, control portion 21 proceeds to step S41. If stored in the permanent storage region, control portion 21 proceeds to step S42. At step S41, the authorized person data that includes the identification information received at step S31 is deleted from EEPROM 28. This is to avoid the acceptance of the second visit by the owner of the mobile phone having the identification information received at step S31.

At step S42, control portion 21 transmits the enabling signal to outdoor unit 10 through communication I/F 24. Then, control portion 21 turns on microphone 22 and speaker 23 (step S43). Control portion 21 turns on microphone 22 and speaker 23 to bring communication terminal 20 into the call-enabled state. Specifically, control portion 21 transmits the voice data output from microphone 22 picking up sounds to outdoor unit 10 through communication I/F 24, applies the voice data received at communication I/F 24 to the speaker and allows the speaker to generate sounds. In addition, control portion 21 causes the image data received from communication I/F 24 to appear on display portion 26. Since control portion 21 enables conversation with a visitor under the condition of input of the enabling signal, the user of communication terminal 20 can decide whether or not he has a conversation with a visitor, of his own will.

At step S44, control portion 21 determines whether or not the end signal is input. The end signal is a signal given by the user of communication terminal 20 to communication terminal 20 to end a conversation with the visitor in the vicinity of outdoor unit 10. The user of communication terminal 20 inputs the end signal to operation portion 27 so that control portion 21 obtains the end signal. Control portion 21 enters the stand-by state until input of the end signal (NO at step S44) and maintains the call-enabled state of communication terminal 20. When the end signal is input, control portion 21 proceeds to step S45. At step S45, control portion 21 transmits the end signal to outdoor unit 10 through communication I/F 24. Then, control portion 21 turns off microphone 22 and speaker 23 (step S46). Control portion 21 turns off microphone 22 and speaker 23 to bring communication terminal 20 into the call-disabled state. Then, control portion 21 ends the process.

It is noted that if the process proceeds to step S47, communication terminal 20 may relay the communication between mobile phone 50 and outdoor unit 10 without turning on microphone 22 and speaker 23. Accordingly, the user of mobile phone 50 can talk with a visitor in the vicinity of outdoor unit 10 using mobile phone 50. In addition, the authorized person data may be stored in mobile phone 50 so that the processes at steps S33-S35 are performed in mobile phone 50.

As described above, in the visitor reception system in the first embodiment, when a visitor brings mobile phone 40 carried by the visitor close to outdoor unit 10, short-range communication portion 15 communicates with IC card 41 of mobile phone 40 to obtain the identification information of mobile phone 40. Outdoor unit 10 transmits the identification information of mobile phone 40 to communication terminal 20, and communication terminal 20 is then notified of the visitor on condition that the identification information received from the outdoor unit is stored as the authorized person data in EEPROM 28. Therefore, only when a person who carries the mobile phone having the identification information registered pays a visit, notification about the visitor is given. Accordingly, it is possible to limit the visitors authorized to enter.

Moreover, outdoor unit 10 communicates with IC tag 41 mounted on mobile phone 40 that enters within the communicable range of short-range communication portion 15, obtains identification information from mobile phone 40 carried by a visitor and transmits the identification information to communication terminal 20. Therefore, the visitor can be identified by the identification information of mobile phone 40 carried by the visitor, and the presence of the visitor can be detected by obtaining the identification information of mobile phone 40.

Furthermore, the image data obtained by picking up an image of a visitor and image data stored in EEPROM 28 in association with the identification information of mobile phone 40 are displayed side by side at the same time, so that the face of the visitor can be checked with the image data registered beforehand. Thus, even if a different person who is not the owner of mobile phone 40 visits as being disguised as the owner of mobile phone 40, it can be informed that a different person is visiting.

### SECOND EMBODIMENT

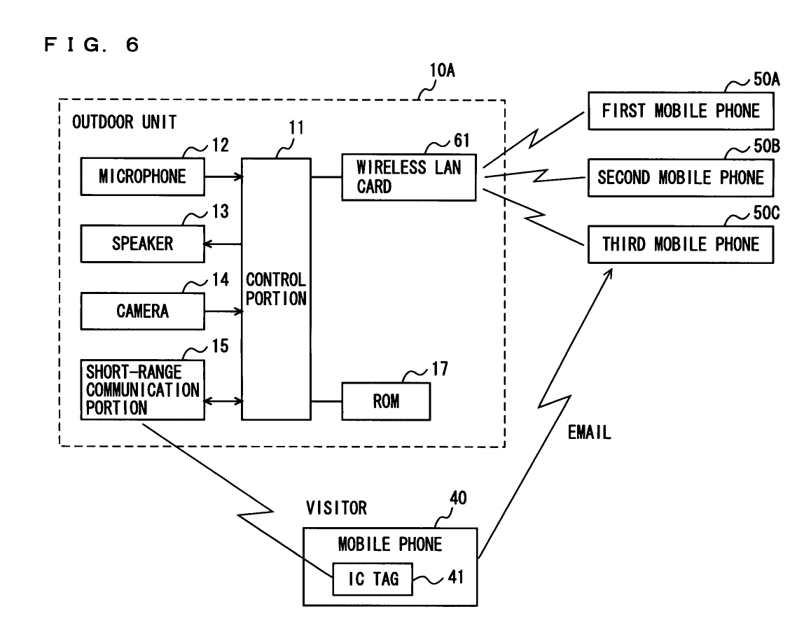

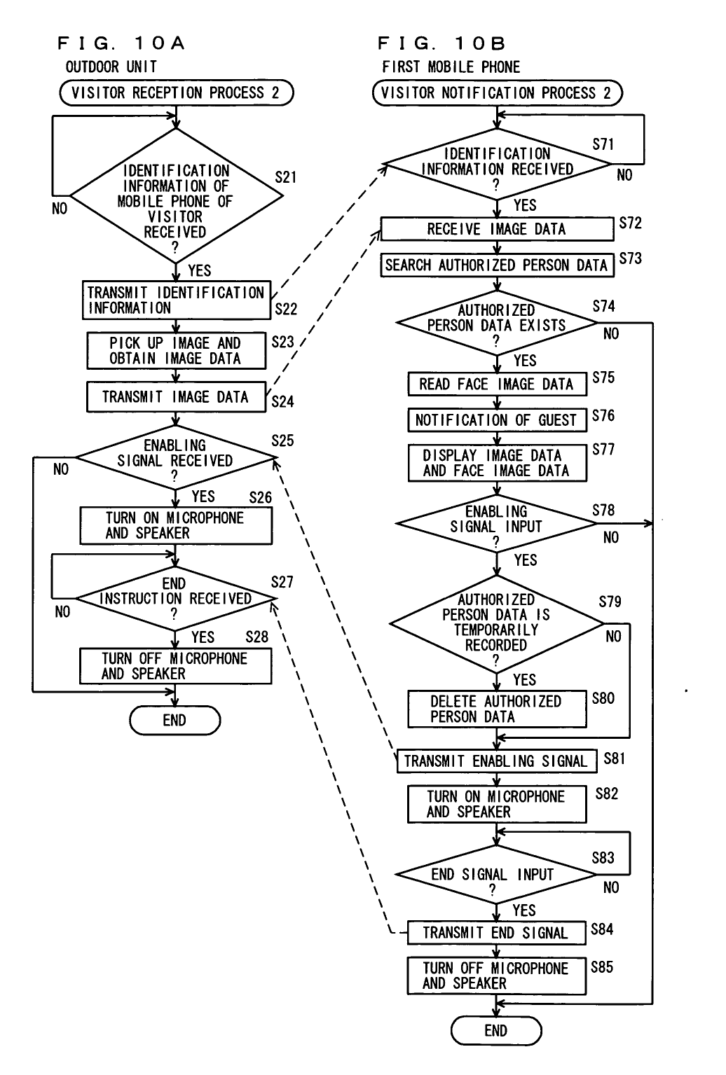

FIG. 6 is a diagram schematically showing a configuration of a visitor reception system in a second embodiment. Referring to FIG. 6, the visitor reception system in the second embodiment includes an outdoor unit 10A and first to third mobile phones 50A, 50B, 50C. First to third mobile phones 50A, 50B, 50C are communication terminals. Outdoor unit 10A has the same members denoted with the same reference characters as outdoor unit 10 shown in FIG. 10. Outdoor unit 10A differs from outdoor unit 10 in that communication I/F 16 is replaced with a wireless LAN card 61. Wireless LAN card 61 is an interface for wirelessly connecting outdoor unit 10A with first to third mobile phones 50A, 50B, 50C. It is noted that although here, first to third mobile phones 50A, 50B, 50C are wirelessly connected with outdoor unit 10A by way of example, only first mobile phone 50A, for example, may be connected to outdoor unit 10A or another mobile phone may be connected to outdoor unit 10A. In short, the mobile phone connected to outdoor unit 10A is one or more and the number of mobile phones is not limited. First to third mobile phones 50A, 50B, 50C have the same functions and therefore first mobile phone 50A will be described here.

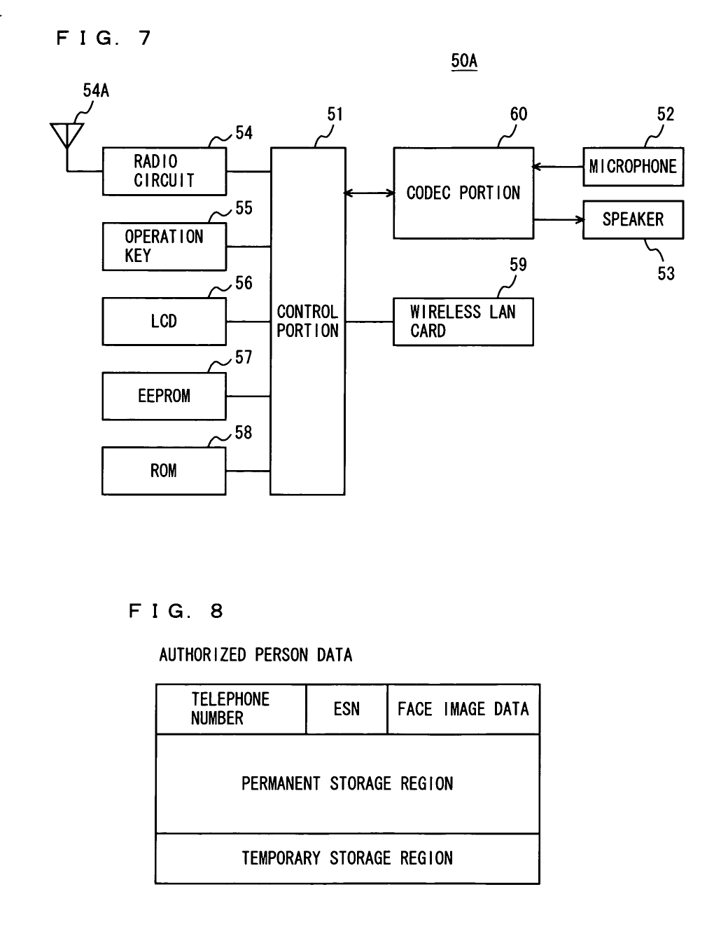

FIG. 7 is a block diagram schematically showing a configuration of the first mobile phone in the second embodiment. Referring to FIG. 7, first mobile phone 50A includes a control portion 51 for controlling the entire first mobile phone 50A, a radio circuit 54 connected with an antenna 54A, an operation key 55 accepting an input of an operation of the user, a liquid crystal display (LCD) 56, an EEPROM 57 for storing authorized person data, an ROM 58 for storing a program executed by control portion 51, a codec portion 60 for processing voice data, and a wireless LAN card 59.

FIG. 8 is a diagram showing an exemplary format of the authorized person data stored in the first mobile phone. The authorized person data is stored in EEPROM 57 of first mobile phone 50A. FIG. 8 shows a storage region of EEPROM 57. The authorized person data includes a telephone number, ESN and face image data. The authorized person data always includes one of a telephone number and ESN and may include both. When the authorized person data includes a telephone number, a data item of telephone book data stored in first mobile phone 50A includes a data item of the authorized person data. Therefore, the telephone book data can be used as authorized person data for permanent storage. In this case, only the authorized person data for temporary storage is stored in EEPROM 58 aside from the telephone book data.

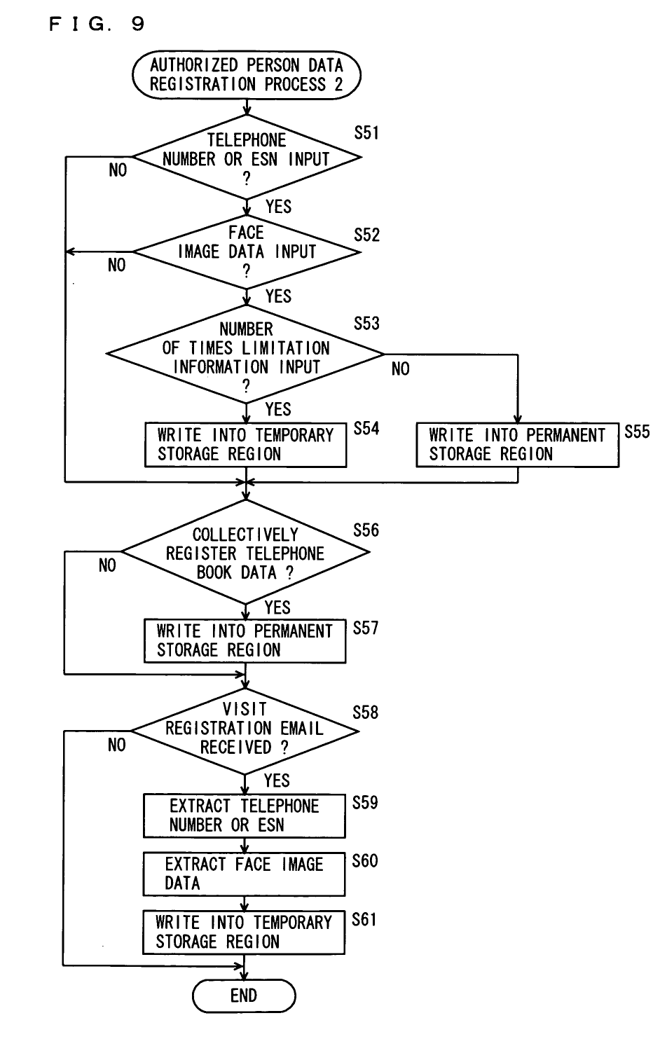

FIG. 9 is a flowchart illustrating an exemplary flow of the authorized person data registration process performed in first mobile phone 50A. The authorized person data registration process is performed in control portion 51 by control portion 51 of first mobile phone 50A executing the authorized person data registration program stored in EEPROM 57 or ROM 58. Referring to FIG. 9, control portion 51 determines whether or not a telephone number or ESN is input (step S51). The telephone number or ESN is input to first mobile phone 50A by the user operating first mobile phone 50A. Control portion 51 causes an input window for the user to input a telephone number or ESN to appear on LCD 56. The user inputs a telephone number or ESN to operation key 55, so that control portion 51 obtains the telephone number or ESN. When the telephone number or ESN is input, control portion 51 proceeds to step S52, and if not input, the process proceeds to step S56. At step S52, control portion 51 determines whether or not face image data is input. The face image data is image data obtained by picking up an image of the face of the owner of the mobile phone having the telephone number or ESN input at step S51. Here, the face image data is obtained by a camera included in first mobile phone 50A. Control portion 51 obtains image data from the camera and proceeds to step S53. If the image data is not obtained, the process proceeds to step S56.

At step S53, control portion 51 determines whether or not number of times limitation information is input. The number of times limitation information is input to operation key 55 by the user of first mobile phone 55. Control portion 51 causes a window for the user to input the number of times limitation information to appear on LCD 56. The user inputs the number of times limitation information to operation key 55, so that control portion 51 obtains the number of times limitation information. When the number of times limitation information is input, control portion 51 proceeds to step S54. If not input, the process proceeds to step S55. It is noted that although control portion 51 causes an input window to appear on LCD 56 at each of step S51-step S53, the input windows displayed at step S51-step S53 may be displayed on LCD 56 at the same time. At step S54, control portion 51 generates authorized person data based on the telephone number or ESN obtained at step S51 and the face image data obtained at step S52 for storage into a temporary storage region of EEPROM 57. On the other hand, at step S55, control portion 51 generates authorized person data based on the telephone number or ESN obtained at step S51 and the face image data obtained at step S52 for storage into a permanent storage region of EEPROM 57.

At step S56, control portion 51 determines whether or not an instruction to collectively register telephone book data is input. The instruction to collectively register telephone book data is input to operation key 55 by the user operating first mobile phone 50A and is thus obtained by control portion 51. When the instruction to collectively register telephone book data is input, control portion 51 proceeds to step S57. If the instruction to collectively register telephone book data is not input, the process proceeds to step S58. At step S57, control portion 51 writes the telephone book data into the permanent storage region of EEPROM 28. Accordingly, the telephone book data that has already been stored in EEPROM 57 can be used as authorized person data. Of the telephone book data that has already been stored in EEPROM 57, only the telephone book data designated by the user may be used as authorized person data. It is noted that in actuality, it is not necessary to copy the telephone book data to be written into the permanent storage region. The region of EEPROM 57 in which the telephone book data has already been stored may be used as the permanent storage region, or the telephone book data that has already been stored in EEPROM 57 may be provided with information such as a pointer. It is noted that if the telephone numbers are grouped in the telephone book data, only a telephone number classified in a particular group, for example, of family or friends may be stored as authorized person data in EEPROM 57. In addition, a telephone number stored in mobile phone 50 as an outgoing call history or an incoming call history may be stored as authorized person data in EEPROM 57. In this case, only a telephone number of outgoing calls or incoming calls over a prescribed number of times may be stored as authorized person data in EEPROM 57.

At step S58, control portion 51 determines whether or not a visit registration email is received. The visit registration email is an email at least including a telephone number or ESN of a person who pays a visit, of emails received at radio circuit 54. The header portion or the subject of the email includes information indicating a visit registration email. The visit registration email may include face image data obtained by picking up an image of the face of a person who pays a visit. Here, the visit registration email includes the telephone number or ESN and face image data of a person who pays a visit, by way of illustration. When it is detected that the visit registration information is received at radio circuit 54, control portion 51 proceeds to step S59. If not detected, the process ends. When it is detected that the visit registration email is received at radio circuit 54, control portion 51 extracts a telephone number or ESN (step S59) and extracts face image data (step S60) from that visit registration email. Then, control portion 51 generates authorized person data based on the telephone number or ESN extracted at step S59 and the face image data extracted at step S60 and stores the same in the temporary storage region of EEPROM 57 (step S61).

FIG. 10A is a second flowchart illustrating a visitor reception process performed in the outdoor unit. The visitor reception process is a process executed in control portion 11 by control portion 11 executing a visitor reception program stored in ROM 17. FIG. 10B is a second flowchart illustrating a visitor notification process performed in mobile phone 50A. The visitor notification process is performed in control portion 51 by control portion 51 executing a visitor notification program stored in EEPROM 57 or ROM 58.

Referring to FIG. 10A, the process flow is the same with the process of the visitor reception process shown in FIG. 4A. However, at step S22, control portion 11 of outdoor unit 10A transmits the identification information of mobile phone 40 received at step S21 by broadcast through wireless LAN card 61. Furthermore, at step S24, control portion 11 transmits the image data obtained at step S23 by broadcast through wireless LAN card 61.

Referring to FIG. 10B, control portion 51 of first mobile phone 50A determines whether or not the identification information transmitted by outdoor unit 10A by broadcast is received (step S71). Control portion 51 is in the standby state until the identification information is received at wireless LAN card 61 (NO at step S71). Upon reception of the identification information, the process proceeds to step S72. In other words, control portion 51 performs the process after step S72 on condition that the identification information is received at wireless LAN card 61. Then, control portion 51 receives the image data transmitted from outdoor unit 10A by broadcast (step S72). Then, control portion 51 searches the authorized person data stored in EEPROM 57 using the identification information received at step S71 as a key (step S73). Control portion 51 determines whether or not the authorized person data that includes the identification information received at step S71 is stored in EEPROM 57 (step S74). If the authorized person data that includes the identification information received at step S71 is stored in EEPROM 57, control portion 51 proceeds to step S75. If not, the process ends. At step S75, the face image data of the authorized person data that includes the identification information received at step S71 is read from EEPROM 57.

Then, at step S76, control portion 51 allows speaker 53 to output a door bell sound in order to give notification of a guest to LCD 56. Thus, the user of first mobile phone 50A can be informed that he has a visitor, if he is within the communicable range of wireless LAN card 61 of outdoor unit 10A. In addition, control portion 51 may display a prescribed message on LCD 56 together with the sound output. The name of the owner of mobile phone 40 may be associated with the authorized person data, or the telephone number or ESN of the authorized person data and the name of the owner of mobile phone 40 may be associated with each other, so that the guest can be specified based on the authorized person data that includes the identification information received at step S71. Therefore, a message, for example, “you have a guest (the name of a guest)” may be displayed. Thus, the user of first mobile phone 50A can be informed of who is a visitor. Control portion 51 displays the image data received at step S72 and the face image data read at step S75 side by side on LCD 56. Therefore, the user of first mobile phone 50A can confirm by the image that the owner of mobile phone 40 is identical with the visitor. It is noted that the image data referred to herein is not limited to still images and includes moving images.

At step S78, control portion 51 determines whether or not an enabling signal is input. The user of first mobile phone 50A inputs the enabling signal to operation key 55 so that control portion 51 obtains the enabling signal. Upon reception of the enabling signal, control portion 51 proceeds to step S79. If the enabling signal is not input, the process ends. At step S79, control portion 51 determines whether or not the authorized person data that includes the identification information received at step S71 is stored in the temporary storage region of EEPROM 57. If stored in the temporary storage region, control portion 51 proceeds to step S80. If stored in the permanent storage region, control portion 51 proceeds to step S81. At step S80, the authorized person data that includes the identification information received at step S71 is deleted from EEPROM 57. This is to avoid the acceptance of the second visit by the owner of the mobile phone having the identification information received at step S71.

At step S81, control portion 51 transmits the enabling signal to outdoor unit 10A through wireless LAN card 59. Then, control portion 51 turns on microphone 52 and speaker 53 (step S82). Control portion 51 turns on microphone 52 and speaker 53 so that communication is established between first mobile phone 50A and outdoor unit 10A to bring about the call-enabled state. Specifically, control portion 51 transmits the voice data output from microphone 52 picking up sounds to outdoor unit 10A through wireless LAN card 59, applies the voice data received at wireless LAN card 59 to speaker 53 and allows speaker 53 to generate sounds. In addition, control portion 51 causes the image data received from wireless LAN card 59 to appear on LCD 56. Since control portion 51 enables conversation with a visitor under the condition of input of the enabling signal, the user of first mobile phone 50A can decide whether or not he has a conversation with a visitor of his own will.

At step S83, control portion 51 determines whether or not the end signal is input. The user operating first mobile phone 50A inputs the end signal to operation key 55, so that control portion 51 obtains the end signal. Control portion 51 enters the stand-by state until input of the end signal (NO at step S83) and maintains the call-enabled state of first mobile phone 50A. When the end signal is input, control portion 51 proceeds to step S84. At step S84, control portion 51 transmits the end signal to outdoor unit 10A through wireless LAN card 59. Then, control portion 51 turns off microphone 52 and speaker 53 (step S85). Control portion 51 turns off microphone 52 and speaker 53 to disconnect the communication between mobile phone 50A and outdoor unit 10A, resulting in the call-disabled state. Then, control portion 51 ends the process.

As described above, in the visitor reception system in the second embodiment, when identification information of mobile phone 40 is received from outdoor unit 10A at each of first mobile phone 50A, second mobile phone 50B and third mobile phone 50C, notification of a visitor is given on condition that the received identification information is stored as authorized person data in EEPROM 57. Therefore, of first mobile phone 50A, second mobile phone 50B and third mobile phone 50C, only the one having the received identification information stored in EEPROM 57 as authorized person data is given notification of a visitor. Therefore, only a visited person is given notification while the other person is not given notification. Thus, the person other than a visited person is not annoyed by unnecessary information.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A visitor reception system comprising an outdoor unit installed outdoors and a communication terminal capable of communicating with said outdoor unit,
said outdoor unit including
a first communication portion to communicate with a radio terminal within a prescribed distance,
a second communication portion to communicate with said communication terminal,
an identification information obtaining portion to obtain identification information of said radio terminal from said radio terminal through said first communication portion, and
an identification information transmission portion to transmit said obtained identification information to said communication terminal through said second communication portion in response to obtaining of said identification information by said identification information obtaining portion,
said communication terminal including
an identification information registration portion to register identification information,
a third communication portion to communicate with said outdoor unit,
an identification information reception portion to receive the identification information of said radio terminal from said outdoor unit through said third communication portion, and
a notification portion to give notification of a visitor in response to reception of said identification information by said identification information reception portion, on condition that said received identification information is registered in said identification information registration portion.

2. An outdoor unit capable of communicating with a communication terminal, comprising:
a first communication portion to communicate with a radio terminal within a prescribed distance;
a second communication portion to communicate with said communication terminal;
an identification information obtaining portion to obtain identification information of said radio terminal from said radio terminal through said first communication portion; and
an identification information transmission portion to transmit said obtained identification information to said communication terminal through said second communication portion in response to obtaining of said identification information by said identification information obtaining portion.

3. A communication terminal capable of communicating with an outdoor unit installed outdoors, comprising:
an identification information registration portion to register identification information;
a communication portion to communicate with said outdoor unit;
an identification information reception portion to receive identification information of a radio terminal within a prescribed distance from said outdoor unit through said communication portion; and
a notification portion to give notification of a visitor in response to reception of said identification information by an identification information reception portion, on condition that said identification information is registered in said identification information registration portion.

4. The communication terminal according to claim 3, further comprising:
an instruction accepting portion to accept an input of an instruction; and
a call portion to enable a call with a visitor through said communication portion, on condition that a permission instruction is accepted by said instruction accepting portion.

5. The communication terminal according to claim 4, wherein
said registration portion registers identification information to be registered permanently and identification information to be registered temporarily in a distinguishable manner and includes a deletion portion to delete said received identification information in response to acceptance of the permission instruction by said instruction accepting portion if said received identification information is identification information registered temporarily in said registration portion.

6. The communication terminal according to claim 3, further comprising an image data reception portion to receive image data obtained by picking up an image of a visitor from said outdoor unit through said communication portion, wherein
said registration portion can register image data in association with said identification information, and
said notification portion includes a display portion to display said received image data and the image data registered in association with said received identification information at the same time.

7. The communication terminal according to claim 3, wherein
said registration portion includes a registration identification information reception portion to receive identification information for registration via a network and registers said received identification information for registration.

8. A visitor reception system comprising an outdoor unit installed outdoors and a plurality of communication terminals capable of communicating with said outdoor unit,
said outdoor unit including
a first communication portion to communicate with a radio terminal within a prescribed distance,
a second communication portion to communicate with said communication terminal,
an identification information obtaining portion to obtain identification information of said radio terminal from said radio terminal through said first communication portion, and
an identification information transmission portion to transmit said obtained identification information to said plurality of communication terminals through said second communication portion, in response to obtaining of said identification information by said identification information obtaining portion,
each of said plurality of communication terminals including
an identification information registration portion to register identification information,
a third communication portion to communicate with said outdoor unit,
an identification information reception portion to receive the identification information of said radio terminal from said outdoor unit through said third communication portion, and
a notification portion to give notification of a visitor in response to reception of said identification information by said identification information reception portion, on condition that said identification information is registered in said identification information registration portion.

9. A visitor reception system comprising:
a registration portion to register beforehand identification information for identifying a radio terminal;
an identification information obtaining portion to communicate with a radio terminal carried by a visitor to obtain identification information of said radio terminal; and
a notification portion to give notification of a visitor in response to obtaining of said identification information by said identification information obtaining portion, on condition that said identification information is registered in said identification information registration portion.

10. The visitor reception system according to claim 9, further comprising an image pickup portion to pick up an image of a visitor to output image data, wherein
said registration portion can register image data in association with said identification information, and
said notification portion includes a display portion to display the image data output by said image pickup portion and the image data registered in association with said obtained identification information at the same time.
